(19) United States
(12) Patent Application Publication
(10) Pub. No.: US 2010/0203265 A1
(43) Pub. Date: Aug. 12, 2010

(54) Synthetic Turf Having Cooling Layer

(75) Inventors: Christopher Tetrault, Amelia, OH (US); Raymond A. Berard, Portsmouth, RI (US)

Correspondence Address: LAFKAS PATENT LLC, PO Box 43289, CINCINNATI, OH, 45243-0289, US

(73) Assignee: SAPTURF, LLC, Cincinnati, OH (US)

(21) Appl. No.: 12/646,250

(22) Filed: Dec. 23, 2009

Related U.S. Application Data
(60) Provisional application No. 61/150,905, filed on Feb. 9, 2009.
(60) Provisional application No. 61/251,579, filed on Oct. 14, 2009.

(51) Int. Cl. A41G 1/00; B05D 3/02

(52) U.S. Cl. 428/17; 427/393.6; 427/393.5; 427/385.5

(57) ABSTRACT

The present invention describes a synthetic turf having super absorbent materials in order to keep the synthetic turf cooler than conventional synthetic turfs.

### CROSS-REFERENCE TO RELATED APPLICATIONS

The present application claims priority to provisional U.S. Patent Application No. 61/150,905 filed Feb. 9, 2009 and to provisional U.S. Patent Application No. 61/251,579 filed Oct. 14, 2009.

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND ON THE INVENTION

1. Field of the Invention

The present invention relates generally to synthetic turf for landscaping, roofing, and athletic fields, and more particularly to synthetic turf having a cooling layer to substantially dissipate heat buildup common with synthetic turf.

2. Description of the Related Art

Traditionally, athletic fields, as well as landscaped areas for homes and businesses, are covered with a natural grass covering. The natural grass is advantageous for cushioning and ability to quickly recover from abuse from weather, people, or both.

In recent years, however, many athletic fields have been converted from natural grass to synthetic turf coverings. The reasons for converting to synthetic turf is most often linked to the high costs and time related to maintaining natural grass. Further, natural grass may have problems growing in certain environmental and man-made conditions, such as for example, desert regions, spaces shaded by buildings, domed fields and high traffic areas. In areas where the natural grass cannot grow properly or adequately, injuries can result from inadequate footing. In addition, poorly growing natural grass is typically not aesthetically pleasing.

Synthetic turf coverings have improved over the years to appear more like natural grass coverings. Other improvements have been made to give more cushioning and elasticity to the synthetic turf to make it more equal to the advantages of natural grass turf.

However, a primary disadvantage of synthetic turf coverings still exists. In particular, most synthetic turf coverings are comprised primarily of plastics, such as, for example, polyolefin. Such plastics absorb, retain, and radiate heat that can increase the temperature on a field to a potentially fatal level. Even the American Academy of Pediatrics has identified infill artificial turf as contributing to elevating a person's core body temperature, thereby leading to heat related injuries such as, for example, heat cramps, heat exhaustion and heat stroke.

It has been found that naked synthetic turf coverings, that is, synthetic tuft coverings without infill material, such as, for example, sand and rubber, can reach temperatures of 140° F. or greater. Natural grass coverings measure about 85° F. under similar circumstances. Essentially, the materials comprising most synthetic turf coverings absorb heat from the sun and retain the heat in the ground to a much greater extent than natural grass coverings. Sand and rubber granules have been used as infill to increase footing and playability of athletic fields, but such infill materials do not mitigate heating issues of infill artificial tuft. In fact, rubber infill may actually contribute to increasing the temperature of the artificial turf. Lighter colored rubber granules and wetting the sand infill have been proposed as a mean by which to try and decrease the overall temperature of the synthetic turf covering, however, such proposals tend to cool the artificial turf for a very limited time and only at an almost insignificant temperature change.

In addition to being related to increasing heat-related injuries, synthetic turf coverings also are associated with heat pollution. The massive amount of heat rising from urban areas is increasingly being linked to both a delay and stimulation of precipitation. Some areas are experiencing a noticeable decrease in much needed rain and snow, while other areas are seeing an increase. There is strong support that heat and pollution from urban areas effects climate in an alarming way; primarily by redistributing water in an undesired fashion.

As such, governments are considering and implementing environmental standards to limit the heat generated from urban areas. Some of the standards call for increased natural green spaces and fewer areas of blacktop and concrete, that is, artificial spaces that buildup and give off great amounts of heat pollution. Typical synthetic turf coverings can behave very much like blacktop when it comes to heat pollution.

Attempts have been made to decrease the temperature of synthetic turf coverings. Attempts to cool synthetic tuft coverings include watering down the coverings. However the water quickly evaporates. More recent attempts include mechanical means in which a series of cooling pipes are constructed under the synthetic turf coverings. However, such mechanical means is expensive and would require removing currently laid synthetic turf coverings.

Ceramic beads having about 50% porosity have been combined with sand and rubber granules to supplement mechanical cooling systems as a means for cooling artificial turf coverings. However, the ceramic beads are unable to hold enough water to significantly decrease the temperature of the synthetic turf covering. Lighter colored rubber has also been proposed as a means for decreasing the temperature of the synthetic turf covering, but also does not lend to significantly decreasing the overall temperature of the synthetic turf covering.

Other means of cooling synthetic turfs are set forth in U.S. Pat. No. 5,153,553 to Tetrault where super absorbent polymers are included in infill. Although such means is successful in decreasing synthetic turf temperatures, the super absorbent polymers in such circumstances risk being separated from the associated synthetic turf due to weather and wear and tear.

Thus, what is needed is an economically affordable means for cooling synthetic turf coverings over a significant period of time without concern of loss of cooling materials which are also environmentally friendly.

### SUMMARY

The various exemplary embodiments of the present invention include a synthetic turf covering. The synthetic turf covering is comprised of a foundation, a plurality of grass-like filaments, and at least one cooling mat. The foundation is selected from one or more of bare ground, stone, gravel, sand, asphalt, cement, and rubber. The plurality of grass-like filaments is attached to a backing layer such that the backing layer is substantially adjacent to the topside of the foundation and the plurality of grass-like filaments extend substantially upward from the backing layer. The at least one cooling mat is comprised of one or more layers wherein at least one of the layers is comprised of super absorbent polymers.

The various exemplary embodiments of the present invention further include a method of cooling a synthetic turf covering. The synthetic turf covering is comprised of a foundation, wherein the foundation is selected from one or more of bare ground, stone, gravel, sand, asphalt, cement, and rubber; and a plurality of grass-like filaments attached to a backing layer such that the backing layer is substantially adjacent to the topside of the foundation and the plurality of grass-like filaments extend substantially upward from the backing layer. The method includes the steps of introducing one or more acrylic polymers admixed with a monomer that causes crosslinking into or below the synthetic turf covering and crosslinking the polymers to form one or more superabsorbent polymers. The exemplary embodiments of the present invention further include synthetic turf covering comprised of a foundation and a plurality of grass-like filaments. The foundation is selected from one or more of bare ground, stone, gravel, sand, asphalt, cement, and rubber. The plurality of grass-like filaments are attached to at least one cooling mat comprised of one or more layers such that at least one of the layers is comprised of super absorbent polymers and is substantially adjacent to the topside of the foundation and the plurality of grass-like filaments extend substantially upward from the at least one cooling mat.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is an illustrated representation of an exemplary embodiment of the present invention.

FIG. 2 is an illustration representing another exemplary embodiment of the present invention in which the cooling mat is positioned above a backing layer.

FIG. 3 is an illustration representing an exemplary embodiment of the present invention in which a plurality of grass-like filaments are tufted to the cooling mat without a backing layer.

### DESCRIPTION OF THE REFERENCED NUMERALS

In reference to the drawings, similar reference characters denote similar elements throughout all the drawings. The following is a list of the reference characters and associated element:
10 synthetic turf covering
20 foundation
21 topside of foundation
30 backing layer
35 plurality of grass-like filaments
40 cooling mat
45 super absorbent polymer

### DETAILED DESCRIPTION

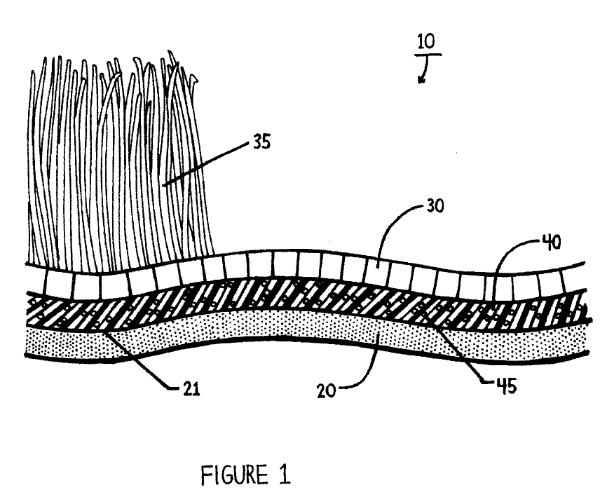

FIG. 1 is an illustration of an exemplary embodiment of a synthetic turf covering 10 of the present invention. As shown, the synthetic turf covering comprises a backing layer 30 resting upon a foundation 20.

The foundation may be bare ground, gravel, sand, rubber, construction materials, or a combination thereof with stone or other similar materials in order to provide support and adequate drainage for the synthetic turf covering.

The foundation may be slightly angled towards strategically placed drain pipes to better and faster drying of the synthetic turf covering's top surface after rain or melted snow.

The backing layer may be comprised of any known woven, non-woven, or spun-bonded fabric to which grass-like filaments 35 may be attached. Examples of conventional backing layers include woven warp type strands or slit film and cross or woof type strands or slit film to produce a woven sheet. It is preferred that the backing layer comprise of a stable, weather resistant material such as polyolefins, nylon, or similar material.

The backing layer is preferably supple and flexible such that it may conform to the foundation layer and potentially give when impacted. The backing layer may also include one or more openings for movement of fluids such as, for example, water.

Grass-like filaments 35 are attached to the backing layer such that the grass-like filaments extend substantially upward, away from the foundation and backing layer. The grass-like filaments may be groups of filaments individually attached to the backing layer or thick individual filaments that are split at the top to give the appearance of numerous individual fibers.

The grass-like filaments may vary in thickness and size to give an appearance of natural grass. Typically, the grass-like filaments are comprised of one or more polyolefins, one or more nylons, or the like.

Any known foundation, backing layer and grass-like filaments may be used in the various exemplary embodiments of the present invention.

The synthetic turf covering may be further comprised of a cooling mat 40 positioned between the topside of the foundation and the backing layer. The cooling mat may be comprised of one or more layers. When more than one layer comprises the cooling mat, each layer of the cooling mat may be of different compositions than other layers. At least one of the layers is comprised of super absorbent polymers on a fibrous substrate.

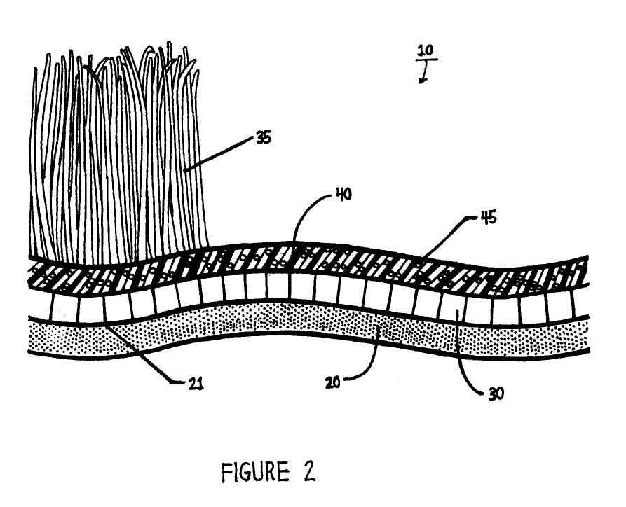

In exemplary embodiments, the cooling mat may be positioned between the topside of the foundation and the backing layer, as illustrated in FIG. 1. In other exemplary embodiments, as illustrated in FIG. 2, the cooling mat may be positioned above the backing layer. In such embodiment, it is preferred that the grass-like filaments are tufted through the cooling mat and primarily attached to the backing layer. In a similar variation, the super absorbent polymer may be formed such that it is crosslinked and polymerized to a tube-shaped surround through which the grass-like filaments are substantially enclosed and attached to the backing layer.

In yet another exemplary embodiment, the cooling mat may be positioned both between the foundation and the backing layer, and above the backing layer, such that there are multiple cooling mat layers. In yet another exemplary embodiment, the cooling mat may be positioned between a first backing layer and a second backing layer.

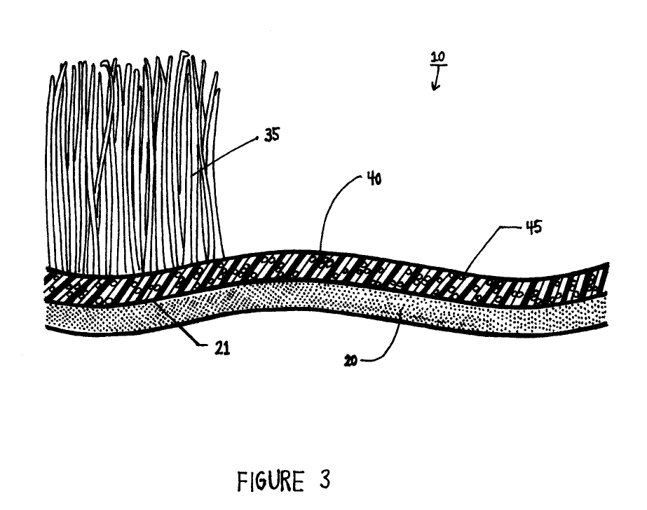

In other exemplary embodiments, the plurality of grass-like filaments are tufted or attached directly to the cooling mat, and there is not an adjacent or attached backing layer. This embodiment is illustrated, for example, in FIG. 3.

The fibrous substrates of the cooling mat may be woven or non-woven, including woven or non-woven polyester, woven or non-woven fiberglass, needle-punched polyester or polyolefin, or any other fibrous substrate that can be coated. Examples of fibrous substrates include spun-bonded polyester or polyolefin. Fibrous substrates useful in the present invention may also be made of other polymers such as, for example, nylon and Kevlar; natural fibers such as, for example, flax, hemp, and wool; or combinations thereof.

The super absorbent polymers of the cooling mat may be, for example, polymers or copolymers of partially neutralized acrylic acid, acrylamide, or acrylic esters as copolymer only. Preferably, the super absorbent polymer may swell in water or other introduced liquids up to about 200 to about 400 times its size. It is also preferred that the super absorbent polymers are nontoxic.

The cooling mat may be prepared by dipping, spraying, and/or dot spraying an aqueous solution of an acrylic monomer and crosslinking agent onto the fibrous substrate. Upon polymerization of the acrylic monomer, the resultant crosslinked polymer should be substantially entangled within the fibrous substrate.

In an exemplary embodiment, the acrylic monomer solution is in the form of the partially neutralized acrylic acid. The partially neutralized acrylic acid is introduced in water to one or more crosslinking agents and UV-sensitive or peroxide reagents. A UV-light or heat may be used to form the polymer as a crosslinked polymer without the crosslinking monomers, but the crosslinking agents assist in better controlling the level and degree of crosslinking and strength associated with crosslinked polymers.

Polymerization of the one or more super absorbent polymers may occur via exposure to ultraviolet (UV) light radiation, peroxides, or other known polymerization process. UV-dependent photoinitiators of polymerization useful in exemplary embodiments of the present invention are water soluble or water dispersible compounds that generate free radicals upon exposure to UV irradiation. Examples of such polymerization initiators include, 4-benzoyl-N,N-dimethyl-N-(2-(1-oxo-2-propenyloxy)ethyl) benzenemethananaminium bromide (available commercially as Quantacure ABQ) in combination with N-methyl-diethanolamine (NMDEA), and 2-hydroxy-2-methyl-1-phenyl-1-propanone (available commercially as Darocure 1173).

When the super absorbent polymers are contacted with water, the super absorbent polymers increase dramatically in size. Depending on the relative size and thickness, the super absorbent polymers may reach maximum moisture retention in as quickly as about ten minutes. After reaching maximum moisture retention the retained moisture slowly releases from the super absorbent polymers depending on the particular conditions present, such as, for example, ambient temperature, sunlight, humidity, etc. Typically, the moisture evaporates from the super absorbent polymers and thereby keeps the backing layer and grass-like filaments cool.

Polymerization and crosslinking of the acrylic monomers and crosslinking agents to form super absorbent polymers within the cooling layer significantly ensures limited movement of the resultant super absorbent polymers relative to the cooling layer, thereby substantially maintaining within the associated synthetic turf covering despite weather, traffic, water flow, and the like upon the synthetic turf covering. Maintaining the super absorbent polymers within the synthetic turf covering decreases the need to have to reintroduce or resupply the synthetic turf covering with cooling materials.

Crosslinking agents instrumental in propagating the polymerization and forming a branched network of polymers include, for example, N,N-methylene bis acrylamide (NMBA), polyethylene glycol diacrylate (PEGDA) and polyethylene glycol dimethacrylate (PEGDMA).

A solution of a polymer, that is, for example, a non-crosslinked acrylic polymer, and a crosslinking agent may also be injected into one or more layers of an already-installed traditional synthetic turf, such that the acrylic polymers are injected into and/or onto the synthetic turf immediately upon being admixed. The means of injecting substances such as, for example, acrylic polymer solutions and crosslinking reagents is known in the art.

The various exemplary embodiments of the present invention further include a method of cooling a synthetic turf covering, that is, for example, a traditional synthetic turf covering that has already been installed. The synthetic turf covering may be comprised of a foundation, wherein the foundation is selected from one or more of bare ground, stone, gravel, sand, asphalt, cement, rubber, and construction materials; and a plurality of grass-like filaments attached to a backing layer such that the backing Page it layer is substantially adjacent to the topside of the foundation and the plurality of grass-like filaments extend substantially upward from the backing layer. The method includes the steps of introducing a solution of one or more non-crosslinked acrylic polymers and one or more crosslinking agents into or below the synthetic turf covering; and crosslinking the acrylic polymer to form one or more superabsorbent polymers. The solution may be introduced via spraying or injecting, and then crosslinked once it is introduced to the desired location relative to the synthetic turf.

In addition to introducing super absorbent polymers into one or more layers of a traditional synthetic turf, a solution of one or more non-crosslinked acrylic polymers and one or more crosslinking agents may be injected or introduced into a synthetic turf in this manner having a cooling mat as set forth herein, in order to resupply, energize, and/or otherwise increase the water retention and cooling effect of the cooling mat.

The life of the super absorbent polymers depends on various conditions, including, for example, adjacent soil conditions, microbes that feed on the super absorbent polymers, foot traffic, weather conditions, and the like. Some super absorbent polymers may have a life of several years and have an estimated cost of less than about one third of a comparative amount of rubber granules.

The cooling mat may be further comprised of at least one neutralizing material to assist in controlling moisture content and liquid absorbing capacities of the super absorbent polymers.

In various exemplary embodiments, the cooling mat is bonded to the backing layer. The bonding may be by way of one or more adhesives, for example. The cooling mat may also be attached to the backing layer via a mechanical means of stitching and/or stapling, for example, by way of the attached grass-like filaments and/or other thread. In other various exemplary embodiments, the cooling mat and backing layer are adjacent but not chemically or mechanically attached.

In a preferred embodiment, even when the super absorbent polymers swell or expand to the greatest extend with water or other fluid, the cooling mat still has channels or openings allowing water, air, moisture, or a combination thereof to flow through to the foundation and ground or evaporation through the synthetic turf covering. Such channels or openings decrease pooling of water or fluids on the surface of the synthetic turf coverings as well.

The cooling mat of exemplary embodiments herein is preferably of an open structure to allow some flow of liquids, air, moisture, or a combination thereof through the cooling layer.

Moisture evaporation will absorb much of the heat from the synthetic turf covering. The cooling mat substantially holds moisture in the polymer and slowly allows evaporation, substantially controlled by diffusion of moisture out of the polymer, cooling the synthetic turf covering over time.

The synthetic turf according to the various exemplary embodiments herein may further include a particulate infill comprised of one or more super absorbent polymers, sand, rubber granules, ceramic beads, soil and combinations thereof. Such particulate infill may be positioned between and around the grass-like filaments.

In various exemplary embodiments of the present invention, when combining super absorbent polymers with sand, rubber granules, ceramic beads, soil or combinations thereof, the particulate infill is substantially homogeneous. That is, for example, it is preferred in various exemplary embodiments that the particulate infill not be divided into various layers of materials.

The particulate infill materials, in conjunction with the grass-like filaments attached to the backing layer, tend to mutually stabilize and hold one another in predetermined position. However, as the super absorbent polymers change size depending on moisture conditions, there is some shifting of the particulate infill materials.

When the super absorbent polymers are at a higher moisture retention, the super absorbent polymers are more flexible and absorb imparted impacts more effectively, thereby potentially reducing injuries to individuals hitting the synthetic turf covering. The overall desired flexibility of impact absorption and playing characteristics desired by a synthetic turf covering may be manipulated by varying the percentage of super absorbent polymers in the particulate infill.

Natural grass may be grown within and through the synthetic turf covering. The natural grass may provide a more realistic appearance to the synthetic turf covering.

The synthetic turf covering may further comprise an underground sprinkler system for applying water to the super absorbent polymers as needed, one or more thermal probes for determining the temperature of the synthetic tuft coverings, or a combination thereof. The one or more thermal probes may be a thermocouple system in substantial contact with the synthetic turf covering and would allow remote monitoring of the installation.

The super absorbent polymers and/or the cooling mat may further be treated with one or more antimicrobial agents, one or more anti-freezing agents, or a combination thereof.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A synthetic turf covering, comprising:
a foundation, wherein the foundation is selected from one or more of bare ground, stone, gravel, sand, asphalt, cement, and rubber;
a plurality of grass-like filaments attached to at least one backing layer such that the at least one backing layer is substantially adjacent to the topside of the foundation and the plurality of grass-like filaments extend substantially upward from the at least one backing layer; and
at least one cooling mat comprised of one or more layers such that at least one of the layers is comprised of super absorbent polymers on a fibrous substrate.

2. The synthetic turf according to claim 1, wherein the at least one cooling mat is positioned on a side of the at least one backing layer furthest from the foundation.

3. The synthetic turf according to claim 2, further comprising multiple tube-shaped surrounds that substantially enclose the grass-like filaments and to which the at least one superabsorbent polymer is polymerized and crosslinked.

4. The synthetic turf according to claim 2, wherein a second cooling mat is positioned on a topside of the foundation and adjacent to the at least one backing layer.

5. The synthetic turf according to claim 1, further comprising a second backing layer such that the cooling mat is position between the at least one backing layer and the second backing layer.

6. The synthetic turf according to claim 1, wherein the at least one cooling mat is positioned on a topside of the foundation and adjacent to the at least one backing layer.

7. The synthetic turf according to claim 1, wherein the one or more super absorbent polymers is a homo-polymer of polyacrylic acid.

8. The synthetic turf according to claim 1, wherein the one or more super absorbent polymers are formed from a solution of one or more acrylic monomers and one or more crosslinking agents.

9. The synthetic turf according to claim 1, wherein one or more super absorbent polymers of the cooling mat are prepared from one or more acrylic monomers that are polymerized by exposure to ultraviolet light radiation, peroxides, or other polymerization method.

10. The synthetic turf according to claim 1, wherein the cooling mat further includes at least one neutralizing material to assist in controlling moisture content of the cooling mat.

11. The synthetic turf according to claim 1, wherein the one or more super absorbent polymers are integrally interconnected within a woven or nonwoven structure comprising the fibrous substrate thereby and will not be transient, thereby be substantially maintained within the cooling mat and not substantially flow.

12. The synthetic turf according to claim 1, wherein the cooling mat is comprised of an open structure to allow some flow of water, air, moisture, or a combination thereof through the cooling mat.

13. The synthetic turf according to claim 1, further comprising one or more thermal probes to substantially indicate a temperature of the surface of the synthetic turf.

14. The synthetic turf according to claim 13, wherein the one or more thermal probes are a thermocouple system which is in substantial contact with the synthetic turf to allow remote monitoring and control.

15. The synthetic turf according to claim 1, wherein the cooling mat and the backing layer are bonded together.

16. The synthetic turf according to claim 1, further comprising a particulate infill for inclusion between the grass-like filaments.

17. The synthetic turf according to claim 1, wherein the one or more super absorbent polymers are nontoxic.

18. A synthetic turf covering, comprising:
a foundation, wherein the foundation is selected from one or more of bare ground, stone, gravel, sand, asphalt, cement, and rubber;
a plurality of grass-like filaments attached to at least one cooling mat comprised of one or more layers such that at least one of the layers is comprised of super absorbent polymers and is substantially adjacent to the topside of the foundation and the plurality of grass-like filaments extend substantially upward from the cooling mat.

19. The synthetic turf according to claim 18, wherein the one or more super absorbent polymers is a homo-polymer of polyacrylic acid.

20. The synthetic turf according to claim 18, wherein the one or more super absorbent polymers are formed from a solution of one or more acrylic monomers and one or more crosslinking agents.

21. The synthetic turf according to claim 18, wherein one or more super absorbent polymers of the cooling mat are prepared from one or more acrylic monomers that are polymerized by exposure to ultraviolet light radiation, peroxides, or other polymerization method.

22. The synthetic turf according to claim 18, wherein the cooling mat further includes at least one neutralizing material to assist in controlling moisture content of the cooling mat.

23. The synthetic turf according to claim 18, wherein the one or more super absorbent polymers are integrally interconnected within a woven or nonwoven structure comprising the fibrous substrate thereby and will not be transient, thereby be substantially maintained within the cooling mat and not substantially flow.

24. A method of cooling a synthetic turf covering comprised of:
introducing a solution of one or more acrylic polymers and one or more crosslinking agents to the synthetic turf;
crosslinking the one or more acrylic polymers to form super absorbent polymers that are substantially retained within or adjacent to the synthetic turf;
wherein the synthetic turf is comprised of
a foundation, wherein the foundation is selected from one or more of bare ground, stone, gravel, sand, asphalt, cement, and rubber; and
a plurality of grass-like filaments attached to a backing layer such that the backing layer is substantially adjacent to the topside of the foundation and the plurality of grass-like filaments extend substantially upward from the backing layer.

25. The method according to claim 24, wherein the synthetic turf covering is further comprised of at least one cooling mat comprised of one or more layers such that at least one of the layers is comprised of super absorbent polymers on a fibrous substrate.

26. The method according to claim 24, wherein the step of introducing the solution is conducted via injection.
